(19) United States
(12) Patent Application Publication
(10) Pub. No.: US 2006/0178976 A1
(43) Pub. Date: Aug. 10, 2006

(54) Real estate business method and system integrating multi-level network marketing, franchise management and web tools

(76) Inventor: Tuan Anh Vu, Las Vegas, NV (US)

Correspondence Address: WEISS & MOY PC, 4204 NORTH BROWN AVENUE, SCOTTSDALE, AZ, 85251, US

(21) Appl. No.: 11/377,723

(22) Filed: Mar. 16, 2006

Related U.S. Application Data
(63) Continuation-in-part of application No. 10/929,022, filed on Aug. 30, 2004.
(60) Provisional application No. 60/499,808, filed on Sep. 3, 2003.

(51) Int. Cl. G06Q 40/00

(52) U.S. Cl. 705/35

(57) ABSTRACT

A real estate business method and system providing an opportunity for members of the general public to receive training in and assist in negotiating and transacting contracts for the sale of real estate. The business method and system include a business affiliation of various organizations including two publicly traded corporations with which parties may form joint venture entities for long-term and/or short-term investment purposes, a website organization for hosting a multi-level interface website over which sales of an investment in real estate are managed, a seminar organization for providing training in real estate transactions, a franchise management organization for providing storefront franchises to graduates of the seminars, and various service organizations to assist in operating the real estate affiliation, including an investment property management organization. Seminars provide training in the methods of the business affiliation, in particular the location and purchase of properties with equity in excess of the purchase price or with positive cash flow. Certified graduates are offered franchises for storefronts and/or seminar training programs and can access higher levels of the website, which provides special tools for the graduates' use. Certified graduates are also offered supervisory positions for guiding and overseeing business affiliation personnel.

### CROSS-REFERENCE TO RELATED APPLICATION

This application is a continuation-in-part of U.S. application Ser. No. 10/929,022, filed Sep. 30, 2004, which is related to U.S. provisional application Ser. No. 60/499,808 filed Sep. 3, 2003 and from which it claims benefits under 35 U.S.C. §119(e).

### BACKGROUND OF THE INVENTION

1. Field of the Invention

The present invention relates generally to real estate business methods, and more specifically to a business method and structure and Internet methods and website for operating a real estate web transaction, education and franchising operation.

2. Background of the Invention

Real estate transactions as to the public, have generally been accessible only as purchases and sales arranged through the viewing and contracting for properties, typically a primary residence through real estate brokers and agents. While Internet auctions of properties have been made on Internet auction sites, Internet sales and auction sites generally do not provide the support and focus required for a user to properly engage in and complete a real estate transaction. Further, Internet sales and auction outlets provide no training in real estate business to the lay person as needed for enabling real estate transactions to become an Internet “e-business”.

Investment real estate transactions, in which multiple parties may purchase and jointly own properties and in which contracts for the sale of real estate may be traded or sold, have generally not been available to the general public at all. Investors in real estate, who may be educated as real estate agents or brokers, educated as attorneys or otherwise having expertise gained through experience, have the advantage in exploiting money-making opportunities through the sole or joint purchase of real estate for investment purposes. The general public can invest in typical long-term investments and until recently, with the advent of stock market day-trading, had little opportunity to take advantage of short-term gain opportunities. While day-trading of securities can be performed via the Internet, no provision is made for Internet support of short-term real estate transactions, as special requirements must be met and users of the system must have training in order to adequately perform many of the steps required to negotiate and transact short-term real estate investments.

Seminar organizations in the past have provided education in investment real estate transactions, particularly with respect to locating properties nearing foreclosure or otherwise available on the market at a price substantially lower than the available equity in the property or potential income from the property. Purchase of such properties provide a significant investment opportunity as well as potential benefit to a mortgagor, who may stand to lose the property and his or her investment or capital entirely unless a buyer is found. However, the education provided by the above-mentioned organizations is generally directed toward individual effort and standard techniques of finding a property, contracting for the purchase and reselling or keeping the property, and not toward building a support structure that can sustain a large-scale real estate operation providing opportunities in a variety of areas for individuals trained by the seminar organizations. Further, such seminars do not provide is an organizational form for their graduates can use to further improve and build a business on what they have learned.

Multi-level network marketing (MLNM) organizations have been developed in the past for selling products and services to the public, and for providing an opportunity for members of the public to make money by selling the products and services, as well as by encouraging others to join the MLNM structure. Commissions on memberships and sales of members are generally collected by the MLNM organizations and paid out in a tiered mechanism that rewards members based on their sales and referrals. However, such organizations generally do not lend themselves to real estate transactions, as most principalities regulate the delivery of real estate commissions to only licensed individuals and within licensed organizations. For example, a typical real estate agency shares commissions in a hierarchical structure, but the commission receivers generally must be real estate agents or brokers. Further, the real estate commissions charged by such entities serve as a bar to effective operation of a real estate investment organization or a MLNM organization involved in real estate sales, as involvement of a broker or agent adds cost (typically 5-8%) at each transaction. Further, the restriction of rewards for sales and referrals to only real estate agents or brokers limits the ability of an MLNM or any organization to properly reward the efforts of a member of the public who does not wish to become a real estate agent or broker and who wants to put their efforts into real estate negotiation, real estate location and many other useful services that may be performed for others.

Therefore, it would be desirable to provide real estate business methods, a real estate business structure and an Internet website for negotiating real estate transactions that provide training, support services and a reward structure to members of the public who wish to become involved in the many facets of real estate sales and investment. It would further be desirable to provide an organizational structure for the graduates of the above-mentioned training, so that they may further improve their ability to earn money and build a business in real estate. It would further be desirable to provide an Internet website that facilitates investment in real estate.

### SUMMARY OF THE INVENTION

The above-stated objectives of providing real estate business methods and structures as well as an Internet website that facilitates investment in real estate, for training supporting and providing rewards to persons wishing to become involved in real estate investment or transactions are provided in the methods and systems described herein.

A business affiliation that includes: two publicly traded corporations with which parties may form joint venture entities for long-term and/or short-term investment purposes, an Internet website corporation for providing a real estate transaction website, a seminar organization for training members of the public in negotiating and executing contracts for the sale of real estate and a franchise management organization for franchising storefronts to graduates of the training seminars. The affiliation also includes various service organizations for supporting the real estate affiliation and its franchisees, as well as a property management organization for managing investment in property.

The business affiliation provides seminars for training persons in the location and execution of contracts for the sale of properties having equity in excess of the purchase price or positive cash flow and certifies graduates of the seminars. Certified graduates are offered franchises such as virtual or actual storefront franchises and/or seminar franchises and franchises are established for the certified graduates if the certified graduates purchase the franchise and after an appropriate waiting period. Certified graduates are also offered supervisory positions within the real estate business affiliation, whereby the certified graduates may guide and oversee other business affiliation personnel.

The website corporation provides a website that has a multi-level interface, where some levels of the interface are available only to certified graduates of the seminars who pay a membership fee. Various features are provided for listing of properties or other interests in real property for sales and purchase. The website also provides tools for operation of franchises and for property location and purchase, as well as advertising for seminars and franchises. The website also provides features for executing multi-purchaser contracts for the acquisition of investment properties, as well as communications and negotiation tools/interfaces for investors to locate and evaluate each other.

The website itself comprises a method, computer system and computer program product for providing the multi-level interface mentioned above.

The foregoing and other objectives, features, and advantages of the invention will be apparent from the following, more particular, description of the preferred embodiment of the invention, as illustrated in the accompanying drawings, wherein like reference numerals indicate like components throughout.

### BRIEF DESCRIPTION OF THE DRAWINGS

FIG. 1 is a block diagram depicting organization of a business model in accordance with an embodiment of the present invention.

FIG. 2 is a block diagram depicting detailed organization of a seminar portion of the business model of FIG. 1.

FIG. 3 is a block diagram depicting detailed organization of a transactional portion of the business model of FIG. 1.

FIG. 4 is a block diagram depicting organization of a property management organization in accordance with an embodiment of the present invention.

FIG. 5 is a block diagram depicting relationships between an organizational model in accordance with an embodiment of the present invention and various internal and external support organizations.

FIG. 6 is a flowchart depicting a flow of property transactions in accordance with an embodiment of the present invention.

FIG. 7 is a flowchart depicting a flow of training promotion and franchise operations in accordance with an embodiment of the present invention.

### DESCRIPTION OF THE PREFERRED EMBODIMENT OF THE INVENTION

The present invention concerns a website and business structure for presenting seminars to the general public, initiating and executing real estate purchases and sales, training persons in the acquisition and disposition of real estate with equity or cash flow and establishing and maintaining franchise, corporate purchases of real estate with equity or cash flow, and joint venture relationships. The business structure operates in conjunction with the website, and the website provides various features for each of the components and members of the business structure.

The business structure illustrated herein is an affiliation of corporations and their franchisees and joint venture entities through the use of Nevada limited liability companies. The corporations are separately held publicly traded entities and their subsidiaries that have contracts with each other that define the relationships and duties between the components of the business structure.

The illustrative business structure or “business affiliation” described herein includes a seminar corporation that markets seminars to the general public and franchises the business of presenting seminars to seminar franchisees or which presents seminars to the general public with co-sponsors. The business affiliation also includes a website corporation that is owns and manages a website for marketing seminars, programs of and providing tools for implementing the goals of organizations within the business affiliation. The business affiliation further includes a “storefront” corporation that franchises individuals to establish actual or virtual “storefronts” for assisting in the location, purchasing and resale of properties with equity in excess of the purchase price or with positive cash flow. The business affiliation also includes a corporation that franchises real estate agents to assist in closing real estate transactions for a set fee. The business affiliation may also include a corporation that provides services in establishing business entities (corporations, LLCs, LLPs) and providing bookkeeping and tax services. The business affiliation may also include a mortgage corporation that lends to qualified members in the real estate transactions and title companies that close and/or insure title. The mortgage company and title companies are familiar with the particulars as to the business methods described herein, in order to facilitate the transactions.

The business affiliation also contains a multi-level network marketing (MLNM) corporation, where initial sales contacts to the business affiliation are recognized in the form of royalties awarded to the referring individual for earnings generated by the referred individual(s) as a percentage of fees paid by the referred individual to the various corporations within the business affiliation, to a level of three referrals deep. The MLNM is used primarily to market the franchises of actual or virtual “storefronts” which are franchisees that facilitate the location, purchasing and resale of properties with equity in excess of the purchase price or with positive cash flow, services of the services corporation and the services of the mortgage corporation. The MLNM is also used secondarily to market the website services of the business affiliation and the real estate agent franchises. The MLNM is also used to market the seminars that are presented by the seminar corporation live and on the website.

The business affiliation also is comprised of two corporations with publicly traded shares for the purpose of purchasing single family, residential real estate, in good condition, with equities that cash flow, “qualified properties.” The publicly traded shares of the two corporations are used as contributions to the joint venture entities in which they own interests. As those entities create cash flow and asset appreciation, the increase in earnings and asset value to the extent of the percentage of ownership of those corporations in the joint venture entities is reflected in the consolidated financial statements of those corporations, which should cause a rise in the value of the shares contributed to the joint venture entities. Those shares can then be sold off to provide capital for more investments, which causes a spiral of appreciation in the remaining shares in the entities, as well as the shares of the stockholders of those corporations. This is a unique feature of this business method.

The “first corporation” is aimed at purchasing qualified properties for short term investments. This “first corporation” is aimed at training managers and property locators and purchasing the qualifying homes at bargain prices and preparing them for sale near the retail price to reluctant owners found by the “second corporation.” The first corporation forms joint venture entities with investors in which the investors own one-half of the entity for the purchase of qualifying homes. County and area exclusive marketing directors, as discussed below, property locators, others who find participants in the entities, and investors are compensated with a percentage of the profits and stock options. The first corporation also forms joint venture entities in which it is the majority owner of the interests and a “branch office sponsor” owns the minority interest for the purchase of qualifying homes. Office personnel are compensated on a percentage of profits and with stock options. The compensation of county and area exclusive marketing directors, property locators, others who find participants, investors, branch office sponsors, and office personnel through only a percentage of profits and stock options is a very highly motivating force that contributes greatly to the success of the business model and which quickly eliminates unproductive members.

The second corporation uses the cash and credit of the reluctant owners, discussed below, to acquire properties for long term investment without tying up the second corporation's cash or credit.

Property locators, investors, franchisee users, and entities in which the first corporation is a majority or minority interest owner may also offer to sell the properties to a person who is not an investor, but who has good credit and wants to buy a property for rental income, tax advantages, and/or appreciation, who also either lacks management skill or time to manage the property, and whose credit is sufficient to permit 100% financing. The above-described person is called a “reluctant owner.” The reluctant owner would like to own several properties, if it were not for management demands and troubles and may be willing to pay a retail price for the property, if it can be financed 100%. Reluctant owners are found through a free portion of the website, infomercials, and print media advertisements appealing to them offering no down-payment properties, through surveys filled out by attendees at the free and paid seminars presented by the seminar corporation and the website corporation, and by word of mouth by the many participants in the franchises, the first corporation, and by a second corporation that participates with the reluctant owners in joint venture entities for the ownership of those qualifying properties. The property locator, investor, franchisee user arrange for the reluctant owner to finance the property for 100% and to close title, perhaps employing the services of the flat-fee real estate franchise corporation franchisee, the mortgage company, the escrow/title companies and/or the certified attorneys, generating more business for them. The availability of reluctant owners adds value to the entire business model as a source of buyers who can provide funds to permit property locators, investors, franchisee users, and entities in which the first corporation is a majority or minority interest owner to cash out their equities in properties on an expedited basis, increasing their annualized rate of return on capital invested. Cashing out equities is the essence of the short-term real estate transaction techniques and is a major factor in making the business affiliation a success. The provision of reluctant owners is a unique factor in this business model.

The second corporation also locates reluctant owners and forms joint venture entities with them for the purpose of holding the properties for the long term. The joint ventures between the second corporation and the reluctant owners use the reluctant owner's credit to purchase the qualifying properties with 100% financing. The reluctant owner forms a Nevada limited liability company “LLC”, discussed below, and deeds the property to the LLC as his or her capital contribution. The second corporation contributes shares of its publicly traded stock to the LLC, as its capital contribution. The LLC holds the property, rents it out, and pre-pays the mortgage using rents and proceeds of the sale of the appreciating stock contributed by the second corporation from its publicly traded shares. The increased equity that results from the pre-payment of mortgages on the properties, accelerating rents, and escalations of market evaluations of the properties is reflected in the increased value of the stocks to the extent of the cumulative percentages of ownership of the second corporation in the many joint venture entities it has with various reluctant owners. This permits more of the stock to be sold at higher prices and the proceeds applied to pre-pay the mortgages, which starts another cycle of spiraling increases in stock value. This is a unique facet of this business method.

Real estate “sales” and “purchases” within the context of the present invention include sales of equity interests in properties. For example, a property owner may sell a fractional interest (or a buyer may buy a fractional interest) in a property in order to raise capital for investment or other purposes. “Sales” also include sales of contractual rights prior to closing, so that effective ownership of a property may be transferred multiple times prior to completion of an actual deed transfer (closing). The inventions that permit these sales to happen in an organized and orderly manner without conflicts between the co-owners are unique to this business method.

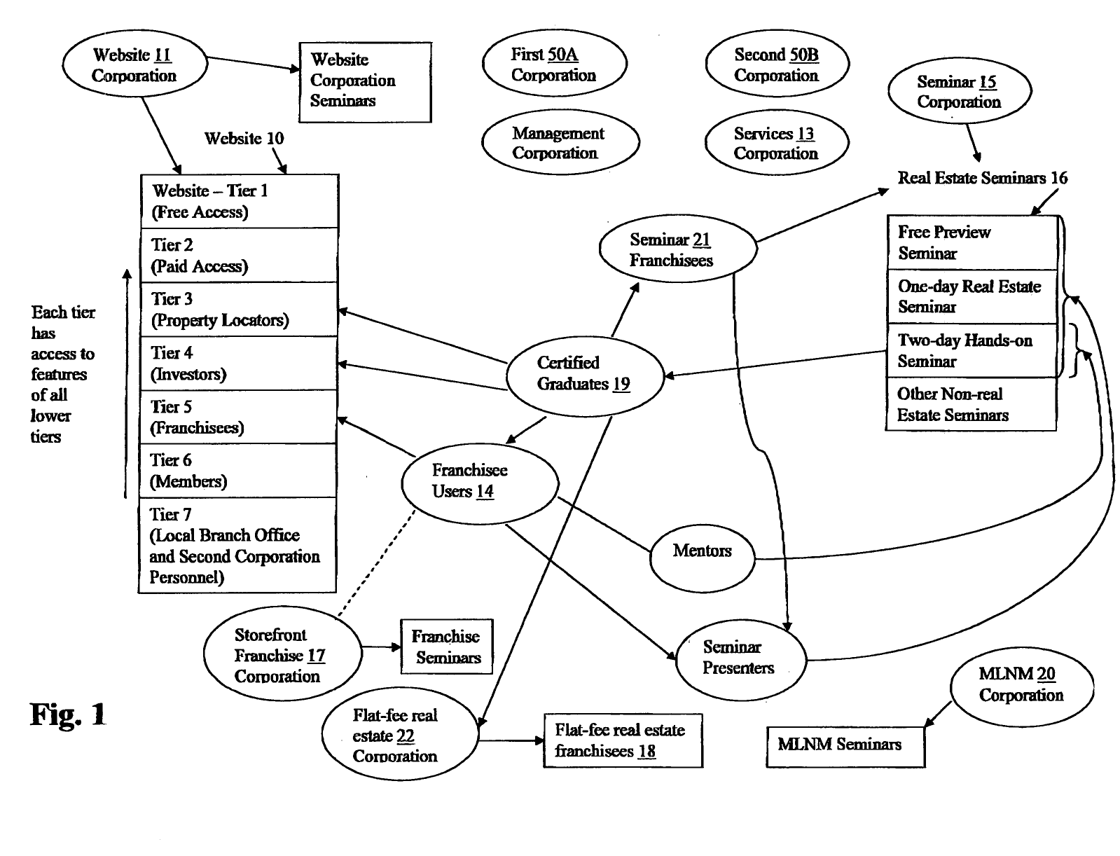

With reference now to the Figures, and with particular reference to FIG. 1, a business affiliation is depicted in which business methods in accordance with embodiments of the present invention are performed. A website 10, owned and maintained by the website corporation 11, is used to execute portions of the business methods described herein, as well as to provide a marketing tool for promoting the options offered by the business affiliation and for selling the seminars. The website 10 generally provides communication between website members, analyzing and improving the performance of members, postings of real estate offerings, notices of seminar offerings and tools for maintaining the relationships between members and the business affiliation. The tools include on-line and printable forms for executing contacts for the sale of real estate and systems for tracking the activities of members, as well as systems for tracking fees, payments and royalties to and from the various elements of the business affiliation.

The website 10 includes seven tiers, the bottom two of which are available to the public. Each higher-level tier includes access to all features of the lower tiers and provides communication with users at the same tier (with the exception of property locator tier 3) and lower tiers, via techniques such as chat or site-bound e-mail transactions where the actual e-mail address of a user is generally hidden from access.

The lowest level, tier 1, is a free access site that permits registered users to upload information about properties for sale or view other properties for sale. Users may register for free and access is provided with a username/password combination. The site also supports property searches at this level, filtered by price, location, type and construction. Free users are not allowed to upload photographs or documents supporting the property offer. Users on tier 1 can communicate with users on tier 2 as well as users on tier 1, as tier 1 and tier 2 users are only offering or seeking properties for sale. A disclaimer is provided to website users that the reliability of information on the website 10 at tier 1 is totally disclaimed by the website corporation 11 and users are advised that the identity and credibility of all users on tier 1 are not verified by the company 11. Tier 1 members may be barred from the website 10 for repeatedly providing false information, but the disclaimer provides that the website company 11 has no liability or responsibility for not barring a tier 1 member.

At the first tier, members are referred via the website 10 to a broker or real estate agent franchised by the business affiliation who can assist in closing, a title or escrow company which is part of the business affiliation, an attorney certified by the business affiliation that is familiar with the business methods and forms used by the business affiliation and its franchisees for closing their transactions.

At a second-tier, which is also available to the public, users are required to pay a monthly service fee for membership, which is paid monthly by credit card. On tier 2, the reliability of information on the website 10 is generally disclaimed, but users are informed that the person providing the information has registered with the website company 11 and has provided a credit card to verify his or her identity. Also, if other users complain of blatant falsehood by a user, that user may be barred by the website company 11, but the company otherwise has no liability or responsibility for not doing so. The verification of identity adds credibility to tier 2 users. Second-tier access permits a user to upload photographs of properties for sale, documents such as mortgages and contracts, and for buyers, letters of pre-qualification for financing a purchase. The pre-qualification letters provide credibility to the users on prospective purchases/offers. The upload capability provides added value to the sellers, as they can provide photos of their properties and/or supply such documents in support of their ownership of and liabilities on property (e.g., mortgages and deeds). At the second tier, offers can be made on properties through the use of on-line interactive forms that create a binding contractual arrangement between a buyer and seller that can be subsequently consummated via a traditional real estate transaction handled either by a broker or real estate agent franchised by the business affiliation, by a title or escrow company which is part of the business affiliation, an attorney certified by the business affiliation that is familiar with the business methods and forms used by the business affiliation and its franchisees 14, or an outside real estate agent or broker, title company, escrow company or attorney.

The third and fourth tiers in the website are accessible only to certified graduates 19 of the training programs provided is or sponsored by the seminar corporation 15, its co-sponsors and/or its franchisees 21. The third tier is available to all graduates of the training programs of the seminar corporation who pay a monthly fee for membership to the website by credit card. The information on the third tier is generally disclaimed by the company 11, but website users are informed that property locators and investors having access to tier 3 are graduates 19 of the training programs of the seminar corporation 15, their identity is verified by credit card and training registration forms, and that tier 3 users are subject to being barred for repeatedly providing false information, but that the website company 11 has no liability or responsibility for not doing so.

The users of the third tier are known as “property locators”. Property locators generally use the website to locate and post information on properties for purchase by themselves, with others or for others and can communicate with users on the lower tiers in order to facilitate transactions. The trading history of a property locator is accessible to investor and franchisee users (tier 4 and 5 users). All of the above information provides additional value and credibility to property locators, as well as investor and franchisee users 14 accessing tier 3 information. The form provided by the website corporation 11 for the posting of the information on a property is specifically designed to provide all information investor or franchisee users 14 need to quickly qualify a property as falling within their purchase criteria, including criteria taught within the seminars. The form provides greater value to both property locators and investor/franchisee users 14.

Property locators are instructed in the use of contract forms proprietary to the business affiliation via the training programs. Property locators cannot contact other property locators and cannot contact users at higher levels. Property locators cannot seek investors other than by posting contracts for purchase using the on-line proprietary forms that can then be searched by users at the higher levels. Property locators are the lowest level of user that can sell or assign their personal property rights, such as mortgages and contracts for the purchase of property that have not been consummated via forms specifically provided for that purpose.

The fourth tier is provided for investors who are certified graduates 19 of the training programs and also pay a monthly fee by credit card. Information on tier 4 is generally disclaimed by the website corporation 11, but a user accessing information from tier 4 is informed that tier 4 users (investor users) are graduates of the training, have had their identities verified by credit card and training registration forms, and are subject to being barred for repeatedly providing false information, however, the company 11 has no liability or responsibility for not barring an individual.

Each investor user's trading history is accessible by other investors and franchisee users 14. The above information adds credibility to an investor and greater value to the website 10.

Investors can post information about their available capital and their investment criteria (e.g., type of property preferred, sole owner only, etc.). Investors can contact each other and view the others' investment information so that agreements can be reached for fractionalized purchase of a property. A lead investor may initiate an attempt to aggregate capital for a combined purchase of property and join other investors who must approve their percentage of ownership and monetary commitment to a purchase as further explained below or an investor can act alone.

The website corporation 11 further provides a tool that is an agreement for the governance of purchases, management, and sale of the property by multiple investors through the use of on-line interactive forms. Another corporation 13 within the business affiliation offers services of forming and maintaining business structures, tax filings, acting as registered agent, and keeping records for the groups of multiple investors, who learn of its services through the website 10, the seminars 16, and emails. The business affiliation thereby provides additional products and services that may be marketed by the “services” corporation 13 and all members, who, upon purchasing a corporate package, qualify to be representatives of the corporate services corporation 13 and can become members of a MLNM marketing group within the services corporation 13. The primary MLNM corporation 20 mentioned above also sells theses services for the corporate services corporation 13.

The fifth tier level in the website 10 is available to franchisee users 14 of the storefront franchise corporation 17 (the corporation that franchises actual or virtual storefronts). Franchisees 14 have access to all other levels, all other information and tools and all other users on the system, as well as to tools on tier 5 for facilitating the operation and organization of their franchises, presentation and promotion of seminars 16, and for communicating with other franchisees 14.

The sixth tier level in the website 10 is available to participants who form joint venture entities with the first corporation 50A. The members of these first corporation joint venture entities have access to all other levels on the website 10 to find properties, but use a separate website for information and tools for facilitating the operation and organization of their joint venture entities, presentation and promotion of seminars, and for communicating with members of other first corporation joint venture entities. Properties held by members of the first corporation joint venture entities are posted on this level but can only be accessed by first corporation joint venture entity members or the second corporation personnel. County and area exclusive marketing directors, others who locate participants, investors and property locators who form joint venture entities with the first corporation 50A are rewarded with stock options and ownership interests in the joint venture entities for finding and mentoring participants in the joint venture.

The seventh and last tier level in the website 10 is available to two types of participants. The first type of participants work for the local offices owned by joint venture entities formed by the first corporation 50A and the branch office sponsor, in which the first corporation 50A is the majority owner. Branch office sponsors act as independent agents of the first corporation 50A to guide and provide oversight to the other workers in the branch offices. This type of independent agent oversight helps to insure that the other workers do not divert opportunities from the joint venture entities and provide local expertise to the other workers. This type of independent agent oversight and mentoring are unique to this business method. Workers include managers, assistant managers, vice presidents of property acquisition, vice presidents of property resales. The second type participant is the second corporation 50B that forms joint venture entities with reluctant owners who will purchase qualified properties to be held long term. The these participants have access to all other levels on the website 10 to find properties, but use separate websites for information and tools for facilitating the operation and organization of their joint ventures, presentation and promotion of seminars, and for communicating with branch office personnel and reluctant owners who have formed joint venture entities with them. Properties held by members of the first corporation joint venture entities are posted on this level but can only be accessed by first corporation joint venture entity members or the second corporation personnel. Workers in the first real estate purchasing corporation 50A are rewarded with stock options and ownership interests in the joint venture entities for finding, mentoring, and participating in the location or resale of properties. They can also get a small ownership percentage in the joint ventures formed by the second corporation 50B for the purchasing of real estate by finding the small investors who participate in those joint ventures.

A second part of the relationship within the business affiliation depicted in FIG. 1 is a training program and business relationship structure outside of the website relationships.

The website corporation 11, the seminar corporation 15, and/or the storefront franchise corporation 17, or a combination of any of these entities, co-produce an infomercial (television information commercial) that promotes not only the website 10, but also the seminar corporation's related seminars 16, the investment programs, and/or the virtual and actual storefront franchise corporation's franchises. The website corporation 11, either alone or together with the seminar corporation 15, its co-sponsors, and/or the virtual and actual storefront franchise corporation 17, conducts a free preview seminar that serves as an introduction and marketing tool for encouraging enrollment in the paid seminars.

The website corporation 11 conducts a one-day paid seminar, in which an attendee is taught the use of the website 10 and basic concepts behind the real estate transactions on the website 10 including: legal concepts, how to locate and acquire real estate with equity, and the use of forms specific to the business affiliation, and in which discounted further training and multiple term website services are encouraged to be purchased. At the one day website seminar, attendees are encouraged to enroll in a one day and/or two day real estate seminar developed by the seminar corporation 15 within the business affiliation. The services corporation's 13 services and products are marketed, either directly or by reference to a separate seminar to be conducted by the corporate services corporation 13 and the storefront franchise corporation's 17 franchise system and its seminars are also marketed by referral to its free seminars.

The one-day real estate seminar teaches in greater detail the process of locating, acquiring, and selling real estate with equity, both by the more classical methods as well as by using the website 10 and being a franchisee of the storefront corporation 17. The teachers at this seminar may either be professional seminar teachers who may or may not have experience specific to the techniques of the business affiliation or more classical methods, or the teachers may be seminar graduates 19 who may or may not be franchisee users 14.

The two-day hands-on training seminar conducted by the seminar corporation gives attendees hands-on experience in the process of locating, acquiring, and selling real estate with equity, both by the techniques of the business affiliation, as well as the more classical methods. The teachers in this seminar are franchisee users 14 and/or other successful graduates 19 of seminars 16 conducted by the seminar corporation 15, its co-sponsors and/or its franchisees 21. Providing instruction by franchisee users 14 or other successful graduates 19 of the seminars 16 gives additional value to the attendees, as attendees will be taught by trainers having specific experience using both classical methods and the methods of the business affiliation, who are successful in the application of those methods.

Mentoring relationships between the attendees and franchisee users 14, successful seminar program graduates 19, co-sponsors or seminar franchisees, are established at the two-day seminar, which benefits the attendees by providing a mentor who is successful in using the business methods of the business affiliation who is accessible at all stages of the new seminar program graduate's efforts to locate, buy and resell property.

The mentoring system benefits the franchisee users 14, successful seminar program graduates 19, co-sponsors and/or seminar franchisees 21 as a means of finding new people to work with who have had training specific to the methods of the business affiliation, as well as a means of finding prospects to participate in the joint venture entities of the first corporation 50A. A two-day seminar is provided by the first corporation 50A related to operation of the joint venture entities. Another two-day seminar is provided related to operation and methods of selling storefront franchises. The mentoring system further provides a system for marketing and selling storefront franchises, franchises to assist in real estate closings, the corporate services corporations' 13 services and recruiting representatives, for which the franchisee users 14, successful seminar program graduates 19, co-sponsors and seminar franchisees 21 receive compensation through the MLNM corporation 20.

Graduates of one or more of the paid seminars are certified graduates 19 of the training program and may become investors, placing notices of available capital on the website 10, franchisee users 14, branch office sponsors, or local or area exclusive marketing directors. Franchisee users 14 may assist the seminar corporation 15, its co-sponsors, its franchisees 21 and/or the storefront franchise corporation 17 in providing training and mentoring that would otherwise have to be provided directly by one of the business affiliation corporations. However, seminar franchisees 21 and storefront franchisees are franchised separately by the seminar corporation 15 and the storefront franchise corporation 17 and therefore graduates may become one or both, depending on which franchises they buy. Seminar franchises are geographically limited. Storefront franchises are not geographically limited. Graduates of the seminars 19 may also become property locators, as knowledge of the use of the proprietary contract forms is required before a person can become a property locator (i.e., a property locator must be a certified graduate of the training program).

The above-described seminars 16 may be presented and promoted by the entities listed above (website corporation 11 for the website seminar, corporate services corporation 13 for the services seminar, etc.), may be provided by seminar franchisees 21 of the seminar corporation 15 or be provided by a joint venture arrangement (referred to herein as co-sponsoring). All seminars are marketed by the MLNM corporation 20. Seminar franchisees 21, co-sponsors, and the MLNM corporation 20 thus provide the seminar corporation 15, services corporation 13 and storefront franchise corporation 17 with additional marketing leverage in areas where the seminar corporation 15, corporate services corporation 13, and/or the storefront franchise corporation 17 might not otherwise host or promote seminars or sell franchises or services.

The seminar corporation 15 sells franchises or enters into co-sponsorship joint ventures to provide seminars 16 and restricts seminar franchisees 21 on a geographical basis. The geographical restriction may be overridden by the seminar corporation 15 or its co-sponsor paying an encroachment fee to the franchisee 21, after the franchisee 21 fails to exercise a right of first refusal to conduct the seminar, which is one of the unique aspects of this business model. Seminar corporation franchisees 21 have the option to fulfill all aspects of advertising and conducting the seminars 16 that the seminar corporation 15 desires to hold in their geographic area, in which event the franchisee 21 pays a license fee equal to a percentage of the gross revenue to the seminar corporation 15, or to pass and receives an encroachment fee from either the seminar corporation 15 or its co-sponsor. A seminar corporation franchisee 21 may be permitted to participate as one of several co-sponsors of the seminar corporation's seminars 16, however, in that case it will not receive the encroachment fee.

The use of co-sponsors and the encroachment fee arrangements are unique features of the business methods of the present invention. The use of franchisee users 14 as trainers and continuing mentor relationships are also unique features of the business methods of the present invention. The use of franchisee users 14 as trainers cuts costs of training and hiring personnel to conduct the seminars 16, and avoids the typical use of professional trainers who may not have actual experience and intimate knowledge of how to locate, purchase, sell, and arrange fractional participations in real estate transactions using the methods taught by the seminar corporation 15.

A franchisee user 14 (storefront owner) may also participate as a co-sponsor of a seminar corporation seminar 16. The seminar corporation 15 and/or its other co-sponsors may also conduct these seminars 16, in the event the seminar corporation franchisee 21 opts to accept the encroachment fee. Seminar corporation franchisees 21 may also pay a licensing fee to use the infomercial produced by the website/seminar/storefront franchise corporations to promote additional seminars in their geographical area or may promote additional seminars by other methods of advertising. The storefront franchise corporation 17 and/or its franchisee users 14 can also pay a licensing fee to use the infomercial produced by the website/seminar/storefront franchise corporations to promote seminars to sell their franchises. The MLNM corporation 20 can also use the infomercial in its marketing program. Seminar corporation co-sponsors may also pay a licensing fee to use the infomercial produced by the website/seminar/storefront franchise corporations to promote seminars. The training program portion of the business as well as the business affiliation as a whole has an agreement with the franchisee users 14 to encourage them to teach the seminars 16 in the training program.

Another franchising component of the business affiliation is the “flat-fee real estate corporation” 22, as mentioned above. Franchisees are recruited by the flat-fee real estate corporation 22 at the various seminars mentioned above as hosted by the other affiliated corporations, by the entities giving those seminars, by the teachers at those seminars, by other flat fee real estate agents, or by members of the MLNM corporation, each of whom get a commission on the sale of the franchise, but not on the royalties on providing services as states require licensing to share those fees. After signing a contract on the website 10 or at a storefront, it is not mandatory that the parties use the flat fee real estate franchisee 18. It is only suggested that they use that service, via a pop-up advertising that appears on the website 10 and sent emails or by referral at a storefront. The website 10 also sells advertising to attorneys, mortgage companies, and title companies that are familiar with the business techniques, preferably graduates 19 of the appropriate seminars or persons certified by the seminar corporation 15. The business affiliation as conceived may include a nationwide mortgage company, insurance company, escrow and/or a title company, the services of each of which will be marketed at the seminar corporation's related seminars 16, the storefront franchise corporation's seminars, the website corporation's seminars, on the website 10 and by the corporate services corporation's 13 representatives.

The first corporation 50A markets its services and programs through county and area exclusive marketing directorships, which are restricted on the basis of location. Investors in these directorships pay a fee for the exclusive rights to develop a county or zip code area through their marketing and mentoring, in return for a percentage ownership in every joint venture entity that is formed in their territory. This includes not only the joint venture entities in which an investor owns one-half of the entity, but also the branch offices owned by joint venture entities in which the first corporation 50A is the majority owner. The county or area director markets to recruit and qualify the branch office sponsors. The county or area director also supervises the seminars given to property locators in their entities. Property locators may also take seminars on-line or in the form of video tapes provided at the local branch offices.

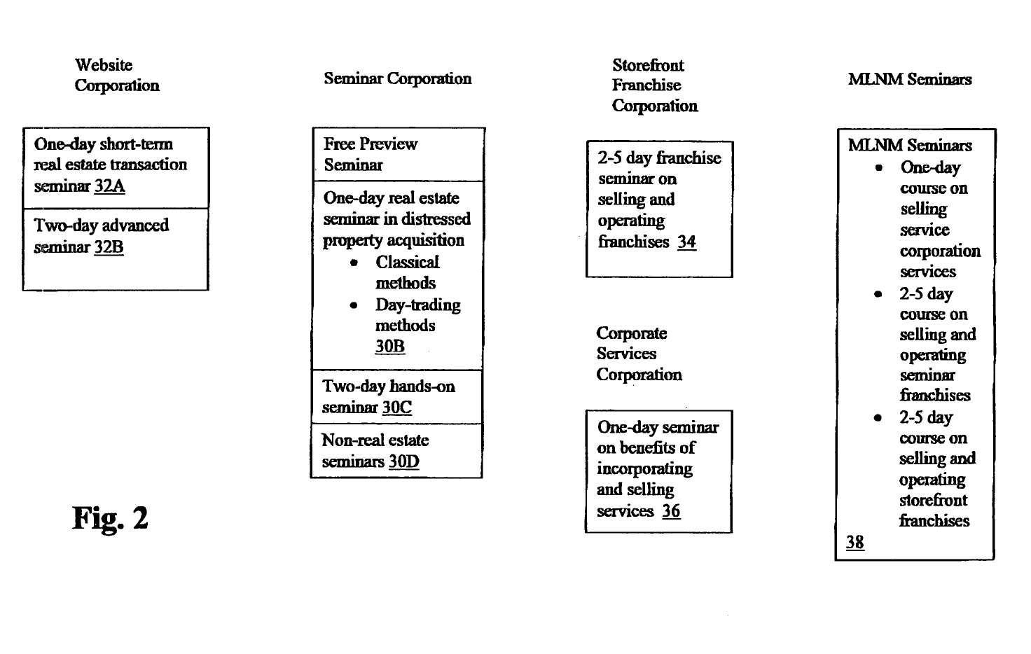

Referring now to FIG. 2, the training program of the business affiliation of FIG. 1 is depicted in further detail. The seminar corporation 15, by itself, or through its franchisees 21 and/or co-sponsors, gives a one day seminar 30B teaching the classical methods of distressed properties acquisition as well as how to use the methods with short-term real estate trading techniques as facilitated by the website 10 and/or through being a storefront franchisee 14. The teachers are professional speakers, graduates of prior seminars who have a record of actual success, and/or franchisee users. The seminar corporation also gives a 2-day, hands-on seminar 30C, by itself, or through its franchisees and/or co-sponsors, but only graduates 19 of prior seminars 16 who have a record of actual success, and/or User Franchisees 14 serve as teachers. The seminar corporation 15 also gives seminars unrelated to real estate.

At the one-day seminar 30B, students are taught the basics of locating and qualifying suitable properties, approaching meeting an owner, qualifying the terms of a sale or other transaction, dealing with lenders and negotiating the purchase of/reselling the properties. In the two-day hands-on seminar 30C, students are familiarized with the process of locating and qualifying properties of finding and meeting an owner, negotiating and executing the contract and reselling the property through participating in the actual process guided by the teacher/mentor. Additionally, students are given hands-on training in executing the proprietary contract forms used by the website corporation 11 and the franchisees 14.

The website corporation 11 gives an online basic real estate locating seminar, one-day short-term real estate transaction seminar 32A and a 2-day Advanced Seminar 32B, using graduates of prior seminars who are successful real estate short-term traders and/or franchisee users 14.

The storefront franchise corporation 17 gives a two to five day training course 34 taught by franchisee users 14 skilled in running its franchises and franchise attorneys, regarding the operation and selling of its franchises.

The corporate services corporation 13 gives a one day course 36 on the benefits of incorporating and on selling the corporate services corporations 13 services and products using successful representatives.

The MLNM corporation seminars 38 comprise a one day course on the benefits of incorporating and selling the corporate services corporation's services and products, using prior seminar graduates who are successful representatives. The MLNM corporation seminars 38 also include a two to five day training course on operating and selling the seminar corporation's franchises, taught by its franchisees 21 skilled in running the franchisees and franchise attorneys, regarding the operation and selling of the franchises. The MLNM corporation 20 also gives a two to five day training course on operating and selling the storefront franchise corporation's franchises, taught by franchisees users skilled in running those franchisees and franchise attorneys, regarding the operation and selling of the franchises.

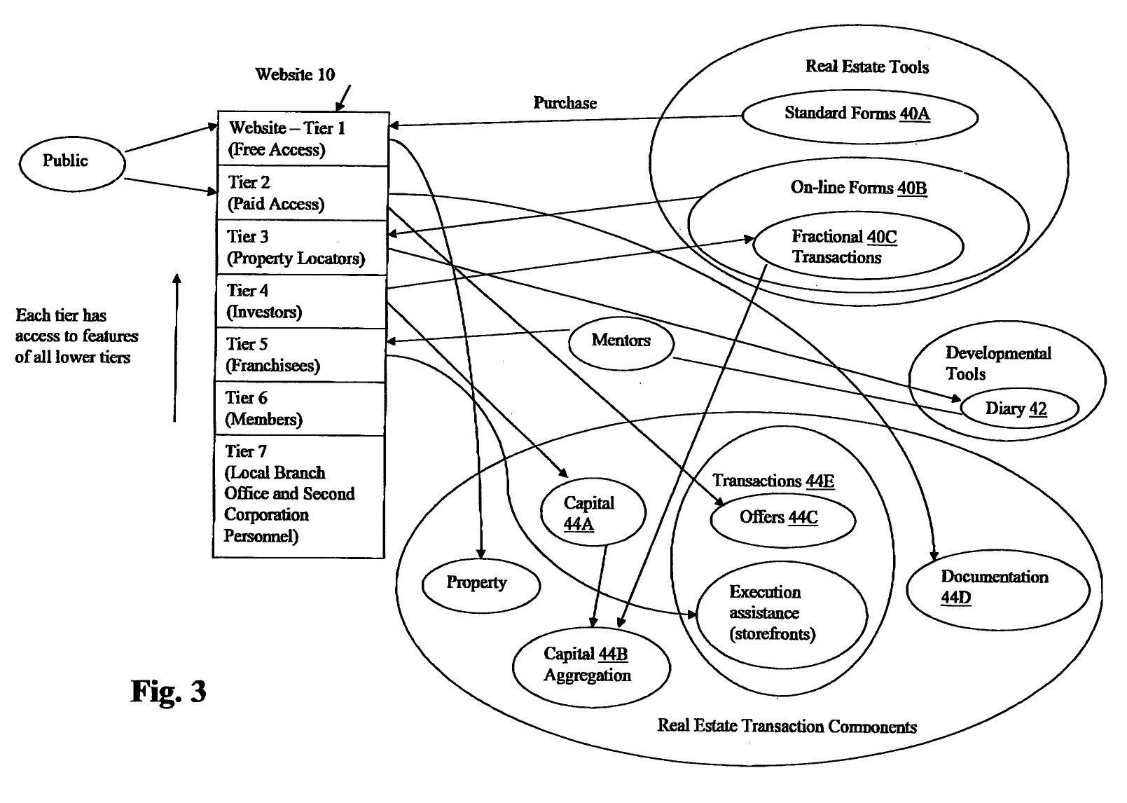

Referring now to FIG. 3, a transactional model of the business affiliation is shown. From the public portions of the website 10, standard forms 40A may be purchased for use as tools in completing a contract for a real estate transaction. The forms 40A are prepared by licensed attorneys for a particular state and are provided with a usage disclaimer. Property sales may be offered and accepted from the public access portions of the website 10, but only as offers between individuals that must be otherwise contracted outside of the system (unless an offer is made by one of the tier 3-7 members in which case the proprietary forms may be used). In any case, a valid real estate transaction closing must be executed after the sales contract as required by the locale.

Paid access public site members of tier 2 may provide documentation 44D as shown in the real estate transaction components, but only members of tier 3 and above may initiate execution of a transaction 44E (via a contract) using on-line forms 40B from the real estate tools. Tier 3-5 members also have a personal diary 42 (a “virtual diary”), generally used by their mentors to review and improve their performance. The mentor 46 also has access to the personal diary 42 of his mentored member. Tier 6 members can buy lower level tier properties and tier 6 properties, but lower levels don't get to access tier 6 properties. The tier 7 member, the second corporation 50B, gets access to all lower levels.

After a contract has been executed, sellers and buyers below level 5 are referred to a franchisee of the flat-fee real estate corporation 18 that is a licensed real estate agent in the area where the property is located. The real estate agent franchisee 18, for a flat fee, will “walk” the buyer and seller through the process of: putting the agreement on state-approved forms 40A (if not using the interactive forms 40B), getting a loan funded and performing title work required for closing. The referral of sellers and/or buyers to real estate agent franchisees 18 is a unique feature of the business methods of the present invention, as typically the assistance described above is only provided by real estate agents who have had an existing client relationship with the buyer and/or seller.

On tier 4, investors (and also franchisee users at tier 5 by inclusion on the lower level) may enter capital amounts 44A and investment preferences for prospective investment in real estate. The capital 44A may be aggregated 44B to show offers 44C on property that is to be fractionalized as described above. When a property is to be bought in fractionalized ownership, a lead investor finds other investors in the system and after every investor has approved the transaction (with respect to their dollar amount and percentage of the transaction) an offer 44C is communicated to the seller. Alternatively, the lead investor may contract the property as a “Buyer” including “assigns” to be determined after the price and terms of the purchase have been secured. The fractionalized transactions are then performed using proprietary forms 40C developed and owned by the business affiliation that ensure proper execution of a fractionalized transaction. Investors' offer, purchase and resell histories are available at the website 10, so that a person participating in the transaction can qualify the lead investor or others participating in the fractionalized transaction.

Debit cards may be issued by a bank under a private label belonging to another corporation within the business affiliation: “the debit card corporation” to provide immediate access to capital as available to the investors. Debit cards may be backed up with any form of capital and may provide international access to capital funds for solo investment in property or used in the fractionalized transactions described above. The cards will be marketed by the debit card corporation, the seminar corporation 15, itself and through its co-sponsors and franchisees 21, the storefront franchise corporation 17, directly and through franchisee users 14, the corporate services corporation 13, directly and through its representatives, the website corporation 11 on its website 10, and the MLNM company 20. Each company and its sales person will receive a fee each time the card is used. The card provides yet another service for each corporation and its members and franchisees to sell.

On level 5, the franchisees are experts in facilitating closings.

On level 6, the office manager or assistant office manager facilitate the closings in the branch offices and the county or area directors facilitate these matters in the joint venture entities in which an investor owns one-half of the interests.

On level 7, the entities that invest with the first corporation have arranged 100% financing for the reluctant owners and the second corporation 50B facilitates the closing of the sales.

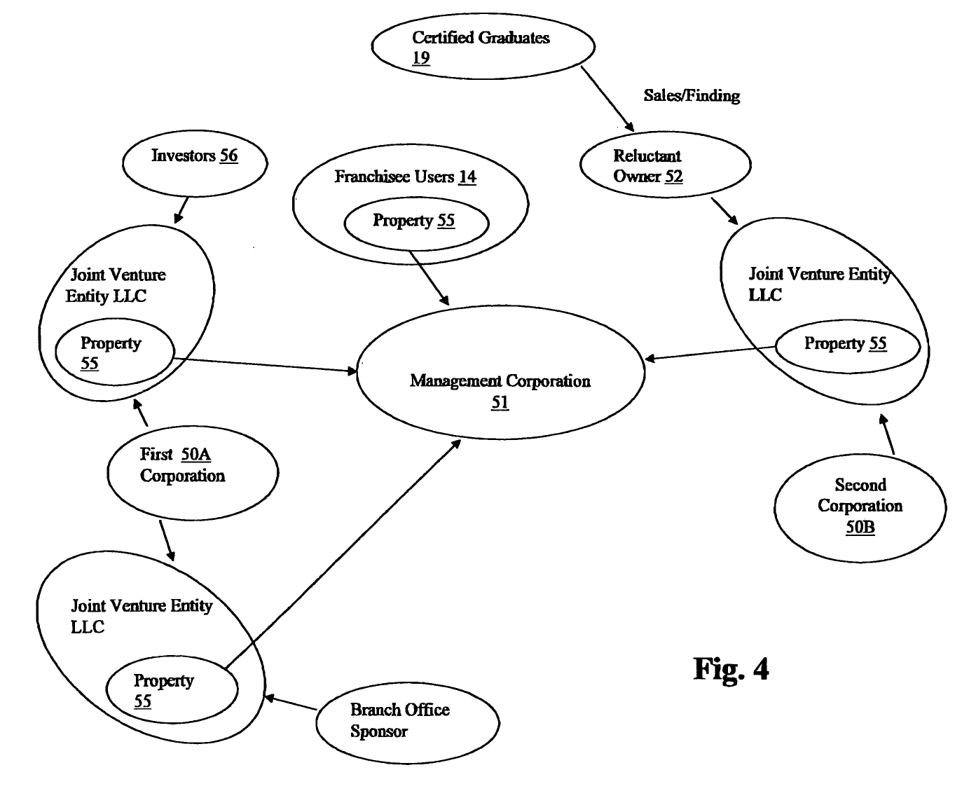

Referring now to FIG. 4, an extension of the business affiliation to management is depicted. A management corporation 51, which is one of the corporations within the business affiliation, may be used to manage properties 55 held by the franchisees, the entities owning the branch offices of the first corporation, the entities formed with investors who own one-half of the interests, or the entities owned by the reluctant owners 52 and the second corporation. This wide client base assures the management company clients and the clients are assured of economies of scale and continuity of personnel in fluctuating employment times. The property 55 may be under contract or have been purchased by another one of the corporations in the business affiliation, an investor, or franchisee user. Property locators may sell the properties to the franchisee users or the entities in which the first corporation is a majority or minority interest owner, or assign their contracts to purchase the properties prior to closing. The entities in which the first corporation 50A is a majority or minority interest owner may assign their contract rights to purchase the properties prior to closing. The ability to assign adds value to business system by providing another source of funds to property locators, investors, franchisee users, and the entities in which the first corporation 50A is a majority or minority interest owner. Property locators or others may suggest properties for purchase by the franchisee users, or the entities in which the first corporation 50A is a majority or minority owner, or assign their contracts to purchase the properties prior to closing and the property may be sold by the management corporation, the entities in which the first corporation 50A is a majority or minority interest owner, or the entities in which the second corporation and reluctant owners are owners to renters in the properties, through direct contact, advertising in papers, or via the website, saving an agency fee. Investors 56 and franchisee users 14 may also sell properties 55 to the entities in which the first corporation 50A is a majority or minority interest owner, or the entities in which the second corporation 50B and reluctant owners 52 are owners of interests or assign their contracts to purchase properties prior to closing.

Testimonials about high-profit in short time periods is a very strong motivational tool to induce attendance at free seminars, leading to higher paid attendance at later seminars, subscriptions to the website companies services, sales of corporate services, sales of virtual or actual storefront franchises, and investors to participate in the entities with the first corporation 50A and the second corporation 50B.

Generally, the management corporation 51 is paid a fee equal to what any other management company in the vicinity would earn. None of the affiliated businesses is required to use or to continue to use the services of the management corporation 51, which assures that the management corporation 51 will provide quality services at a fair price. The Operating Agreements of the LLC in which the second corporation 50B and the reluctant owners 52 are members provides that the reluctant owner 52 can choose whether to use the management corporation 51, a third party, or actively handle the daily property management burden. The reluctant owner might want to actively manage the property if he or she is unsatisfied with the management corporation's 51 or third party's management or to save money. When a property becomes debt-free, the reluctant owner can decide whether or not to hold the property for cash-flow or to sell the property, dissolve the LLC, and distribute the proceeds. The above-described methods of cashing out investors and providing reluctant owners with a management-options method of acquiring paid off properties, with no or a small cash investment, is unique to the invention.

All joint venture entities are required to be Nevada limited liability companies which must be formed by an entity chosen by the member of the business affiliation and which must use identical operating agreements and which provide for registered agents approved by the business affiliates. This assures continuity of operation for all joint venture entities and notification to the business affiliates of any suits. The Operating Agreements provide that all members must participate in the management decisions, except for certain administrative duties that are handled by an administrative manager and certain decisions that are reserved for the investor or the first corporation or second corporation to make to protect their interests. This assures that the members of these entities are actually managing the business of the LLC, instead of being passive investors.

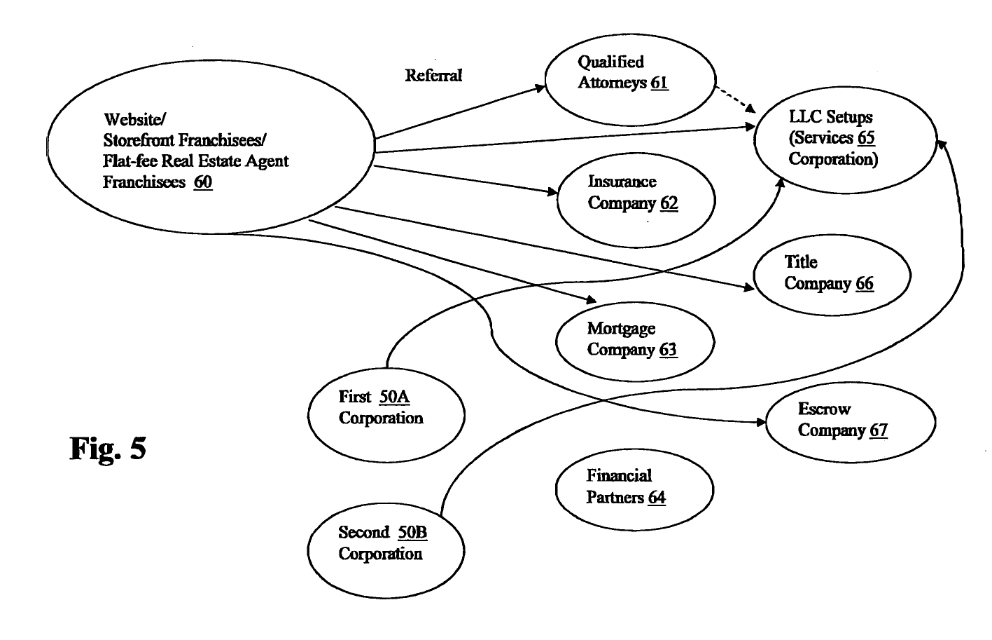

Referring now to FIG. 5, a relationship of the business affiliation as described above to other entities that may be owned entities or outside entities, is depicted. Qualified attorneys are used to generate the forms for the 50 states as sold on the website and are potentially used closings and other legal services. An insurance company, title company, escrow company and a mortgage company may partner with, be owned by, or otherwise form part of the business affiliation in order to provide loan, escrow, title clearance, closings and insurance services to members. In some jurisdictions, escrow and title clearance are performed by qualified attorneys 61, in others, the title company 66 or escrow companies 67 may perform these functions. In some jurisdictions, mortgage services may only be provided by state licensees.

For, large capital investment, financial partners 64 may enter into agreements with the first corporation 50A, the second corporation 50B, storefront franchise corporation 17 and website corporation 11 to invest large capital amounts in real estate 15 with particular investment criteria. Financial partners 64 will typically be institutional funds managers, who transfer capital into the system in exchange for equity held in properties.

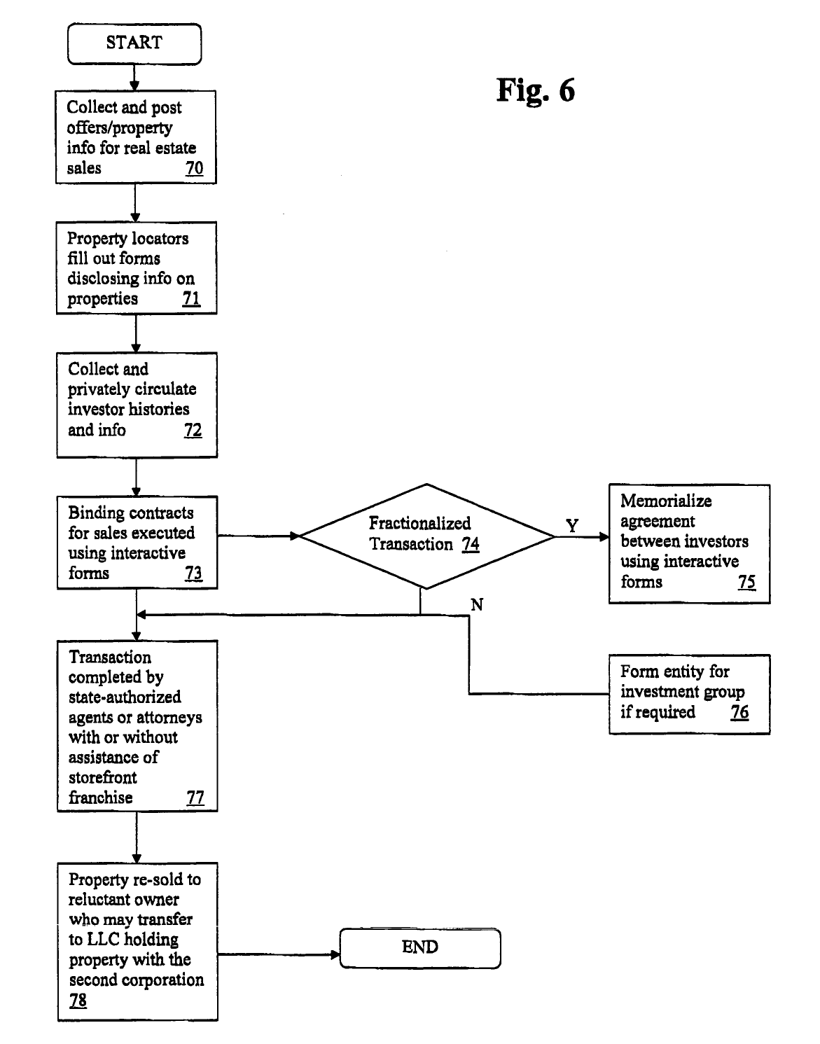

Referring now to FIG. 6, operation of a transactional business system in accordance with an embodiment of the present invention is depicted in a flowchart. Owners, agents, property locators, investors, franchisee users, and entities in which the first corporation is a majority or minority interest owner post properties for sale on the website in the tier or tiers to which they have access (step 70). On tier 3, forms are filled out by property locators that disclose all information to investors and franchisee users to permit them to qualify a property fitting their individual criteria, as well as the criteria taught by the business affiliation (step 71). Property locator, investor, and franchisee user histories are collected by the system and made available to the investors, franchisee users and their mentors as permitted by the rules described above (step 72). Interactive forms for making offers and acceptance are used by the tier 3 and above members to negotiate binding contracts for the purchase of the properties or assignment of contracts on properties (step 73). Investors, franchisee users, and entities in which the first corporation is a majority or minority interest owner can initiate fractionalized investments (decision 74) and if other investors/franchisee users/or entities in which the first corporation is a majority or minority interest owner approve, is they memorialize the agreement (step 75) using interactive forms of offer, assignment, ownership and management governance provided by the website and may include entities formed by the corporate services corporation or independent providers (step 76). The transaction may then be completed by attorneys approved by, escrow agencies or title companies which are affiliated business corporations or by independent entities, with or without assistance by franchisee real estate agents or brokers (step 77). After acquisition, the properties may be held or resold to investors, reluctant owners who may hold them or transfer partial ownership in them to an LLC in which the second corporation is a member, as explained above (step 78).

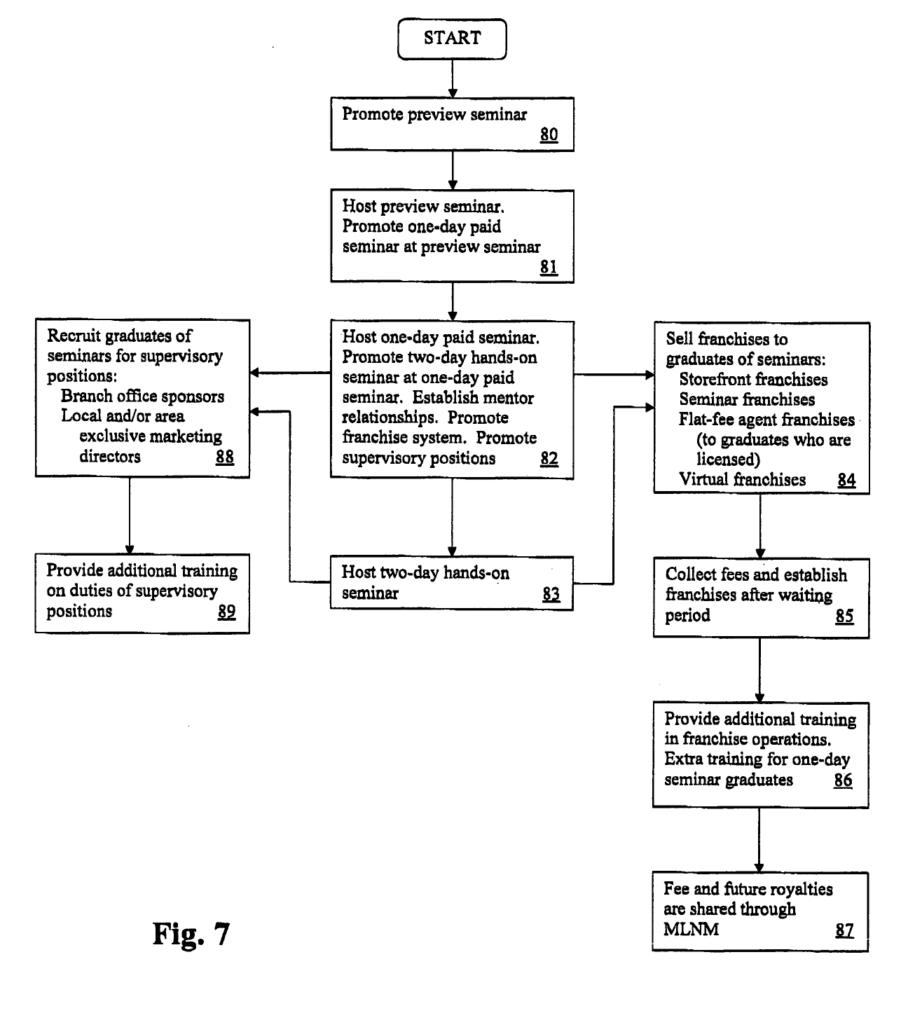

Referring now to FIG. 7, a seminar/franchise/website membership promotion and operation in accordance with an embodiment of the present invention is depicted. The preview seminar is promoted on the seminar corporation's website, the website corporation's website, through e-mail, and through the use of the infomercial on over-the-air television and cable television, and other means in order to draw attendees from the public (step 80). The one-day paid seminar explaining short-term real estate transactions and investment using the website corporation's website is promoted at the preview seminar (step 81). At the one-day seminar, use of the website's forms and methods of property acquisition and resale are taught and a package of discounted website services and training are promoted, is along with the seminar corporation's two-day hands on seminar (step 82). Mentor/mentored person relationships are created at the seminars. Graduates are encouraged to purchase storefront or virtual franchises or to become involved with the entities in which the first corporation is a majority or minority interest owners or to become reluctant owners with the second corporation through their education at the seminars, through their relationships with franchisee-county or area developers, who are the teachers/mentors, by visiting actual storefront franchise offices during and after the seminars, and by being shown virtual franchise storefronts on the website corporation's website (step 84). Graduates are also encouraged to take supervisory positions as branch office sponsors and county or area exclusive marketing directors (step 88).

If a seminar graduate express an interest in purchasing a storefront franchise after the one-day seminar, they can purchase a storefront franchise, but must also attend more extensive post-franchise-purchase training (step 86) than if they purchase a storefront franchise. The storefront franchise collects its franchise fee after the statutory waiting period (step 85) and then pays the franchise fee and a portion of the royalties it will collect to the MLMN corporation (unless the referring member is the seminar corporation), which then redistributes a portion of the franchise fee and royalties it receives through the MLNM affiliation in accordance with whom referred the storefront is franchisee (step 87). If the seminar corporation referred the storefront franchisee, it receives a portion of the franchise fee and of the royalties the storefront franchise corporation will collect.

If a seminar graduate express an interest in purchasing a seminar franchise after the one-day seminar, they can purchase a seminar franchise if one is available for the geographic area they desire after the statutory waiting period, but must also attend more training related to marketing and presenting the seminar.

If a seminar graduate expresses an interest in becoming either a county or area exclusive marketing director, or a branch office sponsor, after the one-day or a two-day seminar, they may do so but must take additional training directed at how to be a county or area exclusive marketing director or branch office sponsor (step 89).

The above-described business method is unique to the business affiliation described herein and includes, but is not limited to: offering joint sales and training seminars, matching property locators with investors and franchisee users via the website and seminars, providing virtual and actual storefront franchises, providing seminar corporation franchises to graduates of the seminar programs, developing counties or areas through exclusive marketing directors, who market, train and mentor members of LLCs who invest in or locate investors to invest in qualified properties, overseeing LLCS that open and operate corporate branch offices through independent branch office sponsors, who hire, train, fire, and mentor office managers and assistant managers, vice presidents of property acquisition and vice presidents of property resale and report on their progress to the corporation, locating qualified properties for sale to reluctant owners and reluctant owners to acquire those qualified property through LLCs that operate company branch offices, through LLCs that are one-half owned by investors, and through the company that will jointly own the LLC into which the qualified property will be contributed, using publicly traded stocks as the capital contribution of the corporations that will be majority or minority interest owners with investors and branch office managers, to the LLCs that will locate the qualified properties or which will jointly own the qualified properties with the reluctant owners, so that as the stocks increase in value, portions may be sold off to use to pre-pay the mortgages, causing a spiraling increase in stock value for the LLCs in which it is held and for the stock holders of the corporations, to further sell the appreciated stock and further reduce the debts, and mentoring of seminar graduates by successful seminar graduates, co-sponsors, seminar franchisees and franchisee users.

Another embodiment is to have preferably a grantor entity such as a corporation, LLC, etc. which can be a public entity that has publicly tradeable shares have a contractual arrangement with a person, persons, other entity, etc. for each regional area such as each of the fifty states of the United States of America. Each contractual arrangement would provide that, in exchange for a significant sum of money such as One Million Dollars or other type of significant consideration, the person, persons, other entity, etc. would enjoy exclusive rights for the specific regional area granted by the grantor entity to conduct various real estate related activities. The receiver of such exclusive rights from the grantor entity for each regional area will have the right to sub-contract with an operator such as a person, persons, other entity etc. for each local type region within the regional area such as each county, city, village, etc. within the regional area to conduct various real estate related activities within each local type region. This sub-contract can be exclusive (or non-exclusive) for each local type region. Cash, line of credit, etc. could be used as consideration (in the sub-contract arrangernent) by each local type operator for receiving the exclusive (or non-exclusive) type right to conduct various real estate related activities within each local type region. People or entitles with management abilities would be selected or used at or for each of the above identified parties.

Accordingly, a partnership type arrangement can be formed between the grantor entity and each regional area representative and a sub-partnership type arrangement can be formed between each regional area representative and each local type operator wherein all parties will share in profits according to an agreed upon percentage for each of the parties. Furthermore, all parties can share in profits received from teaching a real estate investment course for interested people at each local type region. Preferably, the name of each business operation below the grantor entity will be chosen by the grantor entity. Finally, the key business factors for each local type region such as ownership, manager, assistant manager, V.P. of acquisition and sales, etc. will be determined by each local type region with the consent of the regional area representative.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method of operating a real estate business affiliation, comprising:
providing a first publicly traded corporation, said first publicly traded corporation for assisting acquisition of qualifying real property for short-term real estate investment;
providing a second publicly traded corporation, said second publicly traded corporation for assisting acquisition of qualifying real property for long-term real estate investment;
forming at least one joint venture entity, wherein said at least one joint venture entity is partly owned by a party and is partly owned by one of said first publicly traded corporation and said second publicly traded corporation, and wherein said at least one joint venture entity acquires said real property for at least one of investment and resale;
contributing shares to said at least one joint venture entity by one of said first publicly traded corporation and said second publicly traded corporation;
appreciating value of said shares through one of said long-term real estate investment and said short-term real estate investment; and
said at least one joint venture entity selling appreciated shares.

2. The method of claim 1 wherein said short-term real estate investment of said first publicly traded corporation comprises the steps of:
purchasing qualifying real property;
improving said real property for resale; and
reselling said real property.

3. The method of claim 1 wherein said party being an investor and said at least one joint venture entity being equally owned by said investor and said first publicly traded corporation.

4. The method of claim 3 further comprising the steps of:
paying a fee for exclusive rights to market in a specified area by said investor; and
receiving a percentage ownership in any joint venture entity formed in said specified area by said investor.

5. The method of claim 1 wherein said party being a branch office sponsor and said first publicly traded corporation being a majority owner of said at least one joint venture entity.

6. The method of claim 5 wherein said at least one joint venture entity owning at least one local branch office, said local branch office assisting real estate property purchase and resale for said short-term real estate investment.

7. The method of claim 1 wherein said long-term real estate investment of said second publicly traded corporation comprises the steps of:
acquiring qualifying real property;
renting said real property; and
prepaying mortgages on said real property with income received from said renting said real property.

8. The method of claim 1 wherein said party being a previous owner of real property deeded by said previous owner to said at least one joint venture entity as a capital contribution.

9. The method of claim 1 further comprising the step of sharing profits with real estate business affiliation participants and personnel by said at least one joint venture entity.

10. The method of claim 1 further comprising the steps of:
providing seminars for training persons in procedures for locating properties having at least one of equity in excess of purchase price and positive cash flow and executing contracts for the purchase of said properties;
certifying graduates of said seminars as being trained in said procedures;
offering franchises to said certified graduates, whereby said certified graduates can provide services to the public related to said procedures; and
establishing franchises for said certified graduates who accept said offered franchises.

11. The method of claim 10 further comprising the step of offering supervisory positions within said real estate business affiliation to said certified graduates, whereby said certified graduates may guide and oversee other personnel.

12. The method of claim 10, wherein said providing provides seminars for training said persons in the presentation of seminars for training of other persons, wherein said offering comprises offering seminar franchises to said certified graduates, and wherein said services comprise providing seminars for training said other persons.

13. The method of claim 10, wherein said providing provides seminars for training said persons in the operation of storefronts for providing assistance to the public associated with said procedures wherein said offering comprises offering storefront franchises to said certified graduates, and wherein said services are providing said assistance.

14. The method of claim 10, further comprising establishing formalized mentoring relationships between said persons and certified graduates of said seminars, whereby effectiveness of said persons in using methods of said business affiliation is furthered.

15. The method of claim 10, wherein said persons are referred by a certified graduate of said seminars and further comprising rewarding said certified graduate and previous referrers of said certified graduate for said referral according to a multi-level network marketing structure.

16. The method of claim 10, further comprising providing a first website for facilitating locating said properties and executing contracts for the purchase of said properties, wherein said website includes multiple levels of access, at least some of which are only accessible to said certified graduates.

17. The method of claim 16, further comprising the step of providing at least a second website accessible only by a member of said at least one joint venture entity, wherein said website being for facilitation of the operation of said at least one joint venture entity, presentation and promotion of seminars, and for communication with other members of said at least one joint venture entity.

18. The method of claim 16, wherein said multiple levels comprise at least one level accessible only by said franchisees of said established franchises, whereby said franchisees may communicate and access information available at other levels.

19. The method of claim 16, wherein said website further includes tools for execution of multi-owner agreements for the acquisition of real properties, whereby real property investment is facilitated by said website.

20. The method of claim 10, wherein said seminars further include seminars for training said persons in execution of multi-party agreements for the purchase of real properties, whereby real property investment may be facilitated by said certified graduates.

21. The method of claim 10, wherein said persons are licensed real estate professionals, and wherein said franchises are franchises for flat-fee real estate franchises, wherein said certified graduates who are licensed real estate professionals are franchisees who offer flat-fee real estate services.

22. The method of claim 10 further comprising the step of providing a services organization that establishes said joint venture entities.

23. The method of claim 10, further comprising providing a services organization that provides business services to said persons, wherein said persons are referred to said services organization by a certified graduate of said seminars and further comprising rewarding said certified graduate and previous referrers of said certified graduate for said referral to said services organization according to a multi-level network marketing structure.

24. The method of claim 10, further comprising providing a mortgage company that provides loans to said persons, wherein said persons are referred to said mortgage organization by a certified graduate of said seminars and further comprising rewarding said certified graduate and previous referrers of said certified graduate for said referral to said mortgage company according to a multi-level network marketing structure.

25. The method of claim 10 wherein said supervisory position being one of a branch office supervisor and an exclusive marketing director.

26. A method of operating a real estate business affiliation over the Internet, comprising:
providing a first website, said first website having:
a first level interface for posting of properties and interests in properties for sale, said interests including contracts for the purchase of said properties;
a second level interface on said first website accessible only to members of said first website who have paid a membership fee; and
at least one higher level of interface accessible only to a certified graduate of a real estate training seminar offered by said real estate business affiliation for training persons in procedures for locating properties having at least one of equity in excess of purchase price and positive cash flow and executing contracts for the purchase of said properties; and
providing at least a second website, said at least a second website accessible only by a member of at least one joint venture entity formed with a publicly traded corporation belonging to said real estate business affiliation, wherein said second website being for facilitation of the operation of said at least one joint venture entity, presentation and promotion of said real estate training seminars, and for communication with other members of said at least one joint venture entity.

27. The method of claim 26, wherein said at least one higher level of interface includes a franchisee interface, wherein only a franchisee member of said first website may access the franchisee interface, and wherein said franchisee interface provides access to all other levels of said first website.

28. The method of claim 26, wherein said at least one higher level of interface includes an investment interface having tools for execution of multi-owner agreements for the acquisition of real properties, whereby real property investment is facilitated by said first website.

29. The method of claim 28, wherein said at least one higher level of interface includes an information interface whereby prospective parties to said multi-owner agreements may view histories of other prospective parties to said multi-owner agreements.

30. The method of claim 26, wherein said at least one higher level of interface includes a member interface wherein only a member of a joint venture entity formed with a first publicly traded corporation may access said member interface and wherein said member interface provides access to all other levels of said first website.

31. The method of claim 26, wherein said at least one higher level of interface includes a personnel interface wherein only personnel of a local branch office owned by a joint venture entity formed with a first publicly traded corporation and personnel of a second publicly traded corporation may access said personnel interface and wherein said personnel interface provides access to all other levels of said first website.

32. The method of claim 26, wherein said at least one higher level of interface includes a diary interface whereby progress of said certified graduate in real estate business is recorded, and wherein said diary interface is accessible by a mentor of said certified graduate.
